(19) United States
(12) Patent Application Publication
(10) Pub. No.: US 2002/0021510 A1
(43) Pub. Date: Feb. 21, 2002

(54) All weather color filter

(76) Inventors: Richard J. Romano, Moreno Valley, CA (US); Wallace R. Daniels, Moreno Valley, CA (US); Thomas J. Maloney, Redding, CA (US)

Correspondence Address: DAVIDSON, DAVIDSON & KAPPEL, LLC, 14th Floor, 485 Seventh Avenue, New York, NY, 10018, US

(21) Appl. No.: 09/738,386

(22) Filed: Dec. 16, 2000

Related U.S. Application Data
(60) Provisional application No. 60/171,064, filed on Dec. 16, 1999.

(51) Int. Cl. F28F 7/00; G02B 5/22

(52) U.S. Cl. 359/885; 165/138

(57) ABSTRACT

An environmentally sealed color filter is provided which includes a housing having a top side, a bottom side, a front side, a rear side, and a pair of lateral sides, the housing having a first window on the front side and a second window on the rear side. The housing is substantially water-proof or impermeable to water in that when submerged in water at depths of up to 50 feet and for time periods of up to 24 hours, no water will pass from the exterior of the housing to the interior of the housing. A color filter, such as the Color Fader™ color filter manufactured by Morpheus Technologies, LLC and described in U.S. Pat. No. 5,126,886, is secured within the housing. Also secured within the housing is at least one heat exchanger. The heat exchanger dissipates heat generated within the housing.

This application claims priority from Provisional Application Ser. No. 60/171,064, entitled ALL WEATHER COLOR FILTER, filed: Dec. 16, 1999, the entire disclosure of which is hereby incorporated by reference.

### FIELD OF THE INVENTION

The present invention relates to the field of color filters for light projectors.

### BACKGROUND OF THE INVENTION

Theatrical productions make wide use of colored spotlight projectors. Such spotlights typically project beams of white light through filter substrates dyed with filtering media of selected color hues and saturations. Two or three different colors of filtering media can be combined to produce intermediate hues and saturations of color.

U.S. Pat. No. 5,126,886, the entire disclosure of which is hereby incorporated by reference, discloses a color changer which includes a component hue saturation filter including an elongated flexible substrate having a surface with a gradient axis and which includes a graded portion supporting a uniform concentration of a selected hue filtering material distributed in a continuously graded average density in beam-size areas around points along the gradient axis. The component hue saturation filters may be embodied in separate substrates positionable in parallel planes to be intersected serially by a beam of light. Alternately, dual-hue filters may be formed by two primary hue component filters embodied in respective substrates each also embodying duplicate third primary hue component filters producing the same effects. Saturations of each selected hue of light appear evenly distributed in the output beam without the need for color components to be further commingled.

### SUMMARY OF THE INVENTION

A disadvantage of current color filters for light projectors is that they are not environmentally sealed. Therefore, they cannot be used in under-water applications, and cannot be used for extended periods in inclement weather such as rain or snow. In accordance with the present invention, an environmentally sealed color filter is provided which includes a housing having a top side, a bottom side, a front side, a rear side, and a pair of lateral sides, the housing having a first window on the front side and a second window on the rear side. The housing is substantially water-proof or impermeable to water in that when submerged in water at depths of up to 33 feet and for time periods of a least 24 hours, no water will pass from the exterior of the housing to the interior of the housing. Preferably, the housing will remain substantially waterproof or impermeable to water for at least two years. Most preferably, the housing is also air tight. A color filter, such as the Color Fader color filter manufactured by Morpheus Lights, Inc. and described in U.S. Pat. No. 5,126,886, is secured within the housing. Also secured within the housing is at least one heat exchanger. In accordance with the present invention, the heat exchanger dissipates heat generated within the housing. Preferably, a pair of heat exchangers are secured within the housing. The heat exchanger(s) may be of any known construction, but preferably comprise a fan and a heat sink comprised of a plurality of fins. In addition, heat sinks, preferably comprised of a plurality of fins, may also be disposed on the exterior of one or both of the front and rear sides.

In accordance with a further embodiment of the present invention, a transparent panel made of a material that blocks or reflects ultra violet radiation is mounted on the interior of rear housing covering the second window. The transparent UV blocking material can alternatively be mounted on the exterior of the rear housing covering the second window. As another alternative, the rear window itself may be made of a UV blocking material.

### BRIEF DESCRIPTION OF THE DRAWINGS

FIG. 1 and 1D shows front perspective exploded views of an all weather color filter in accordance with a preferred embodiment of the invention.

FIG. 1A and 1B show side views of the color filter of FIG. 1.

FIG. 1C shows an all weather color filter mounted in front of a light source.

FIG. 2A is a side view of a front housing panel of FIG. 1.

FIG. 2B is a rear view of the front housing panel of FIG. 2A

FIG. 2C is a crossection through the front housing panel of FIG. 2A.

FIG. 2D is a front perspective view of the front housing panel of FIG. 2A

FIG. 2E is a front view of the front housing panel of FIG. 2A.

FIG. 2F is a cross-section through the front housing panel of FIG. 2A.

FIG. 2G is a rear perspective view of the front housing panel of FIG. 2A

FIG. 2H is a detailed view of a portion of FIG. 2B

FIG. 3A is a side view of a rear housing panel of FIG. 1.

FIG. 3B is a rear view of the rear housing panel of FIG. 3A

FIG. 3C is a cross-section through the rear housing panel of FIG. 3A.

FIG. 3D is a front perspective view of the rear housing panel of FIG. 3A

FIG. 3E is a front view of the rear housing panel of FIG. 3A.

FIG. 3F is a cross-section through the rear housing panel of FIG. 3A.

FIG. 3G is a rear perspective view of the rear housing panel of FIG. 3A

FIG. 3H is a detailed view of a portion of FIG. 3B

### DETAILED DESCRIPTION OF THE PREFERRED EMBODIMENTS

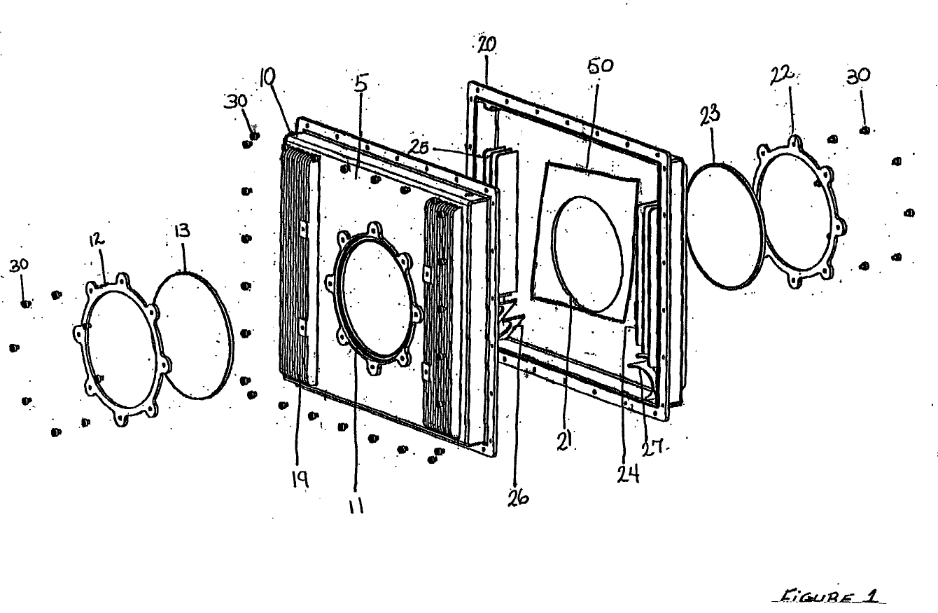

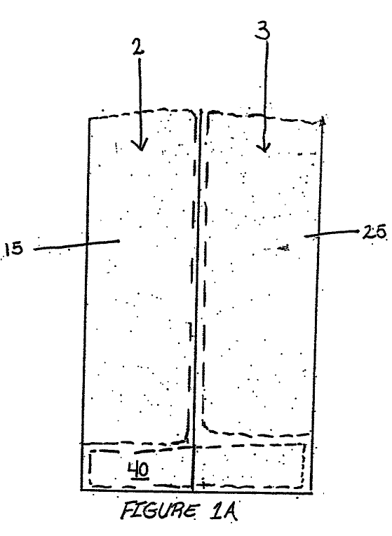

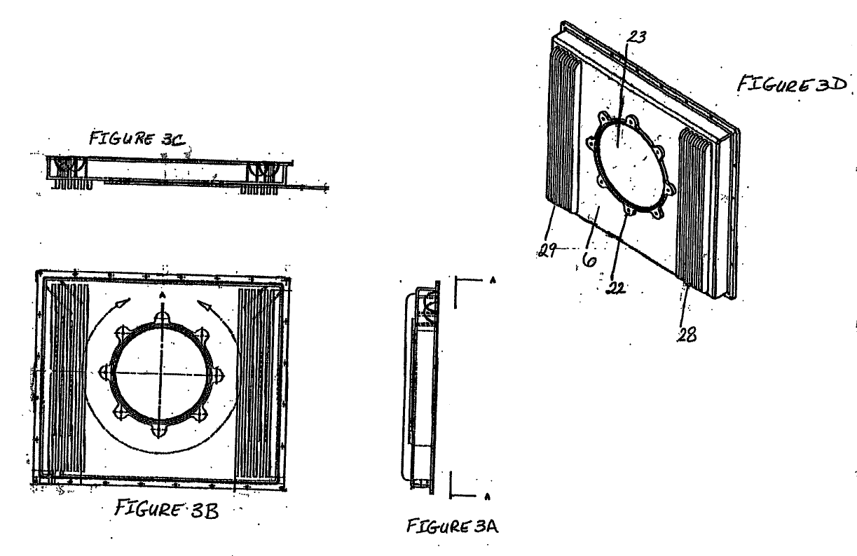

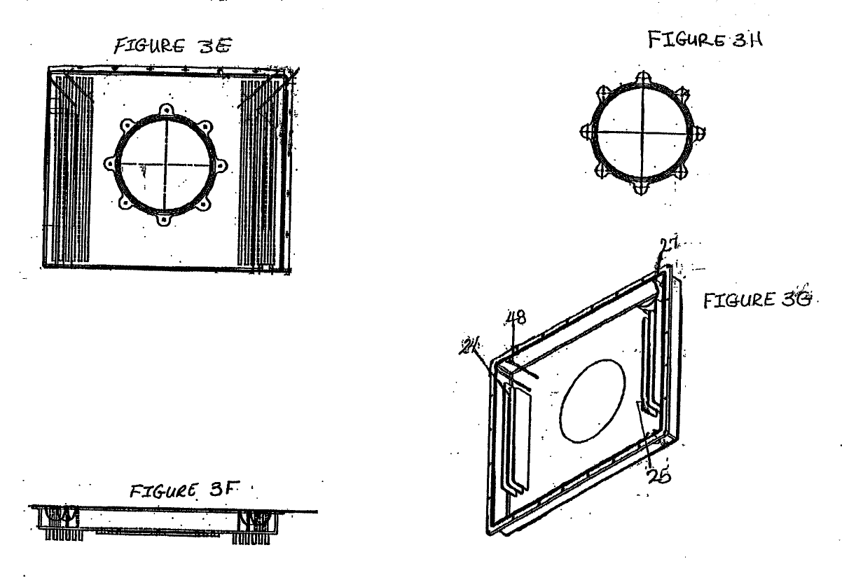

Referring to FIGS. 1 through 3H, all weather color filter 100 includes a water-proof housing 1 in which is disposed a conventional color filter 54 such as the Color Fader™ manufactured by Morpheus Technologies, LLC. The housing 1 includes a front housing panel 10 and a rear housing panel 20, which are secured to each other via screws 30 and gasket 53 to provide a waterproof design. In use, all weather color filter 100 is mounted in front of a light source 101 (FIG. 1C) thereby allowing an operator to change the color of the light projected from the light source.

In the context of the present application, a housing in accordance with the present invention is “water proof” and “impermeable to water” if, when submerged in water at depths of up to 33 feet and for time periods of up to 24 hours, no water will pass from the exterior of the housing to the interior of the housing. However, the preferred housing 1 shown in FIGS. 1-3H is air tight, and will remain substantially water-proof or impermeable to water when submerged in water at depths of up to 33 feet and for at least two years.

Front panel 10 and rear panel 20 have respective circular cutouts 11 and 21 formed therein. Cut-outs 11 and 21 are sealed in a water-proof manner by respective transparent windows 13 and 23, seals 12 and 22, and screws 30. The windows can be formed of any suitable transparent material, but are preferably made of tempered glass. Front panel 10 also has a pair of heat sinks 18 and 19 disposed on its front face 5. Rear panel 20 similarly has a pair of heat sinks 28 and 29 disposed on its front face 6.

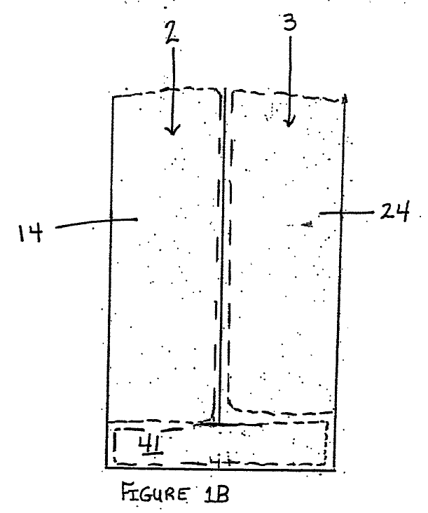

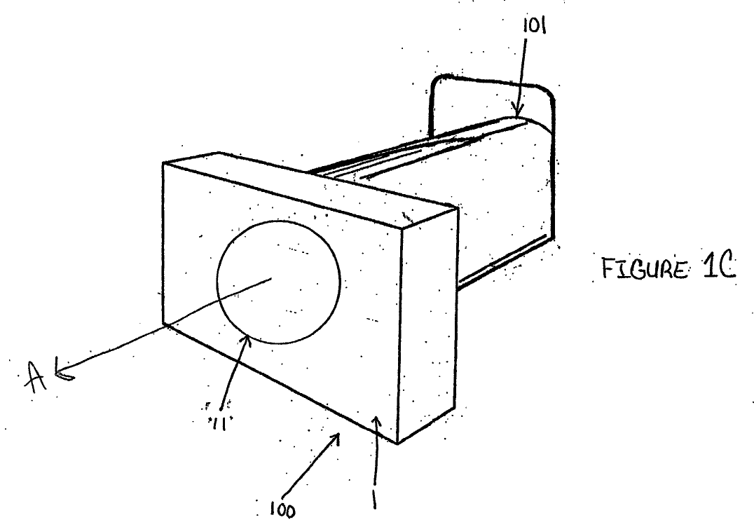

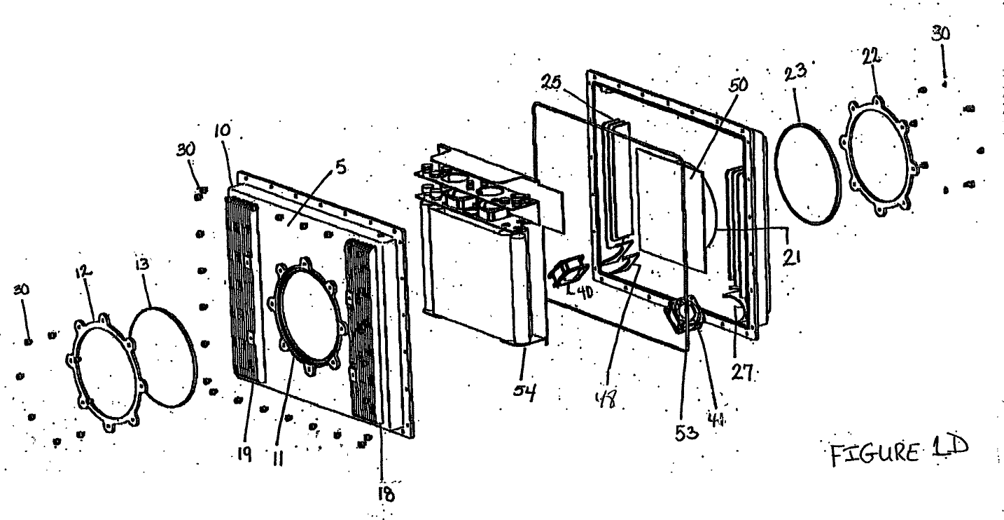

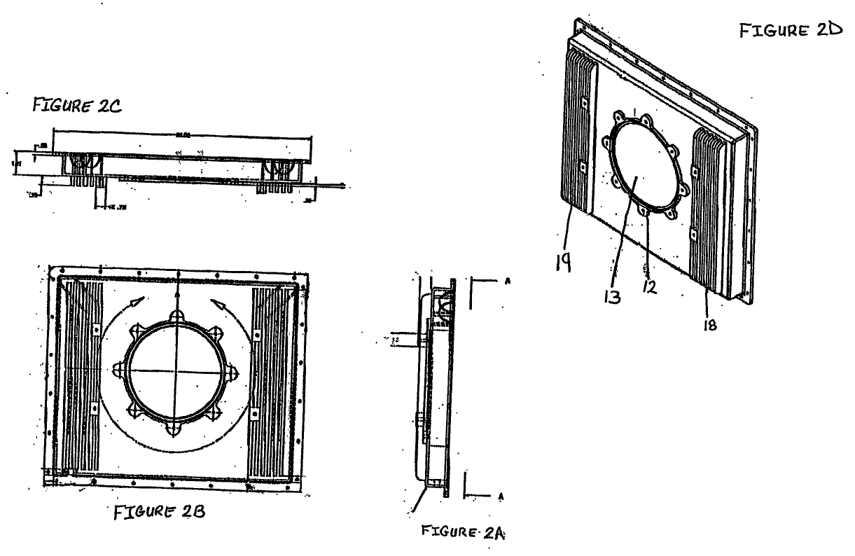

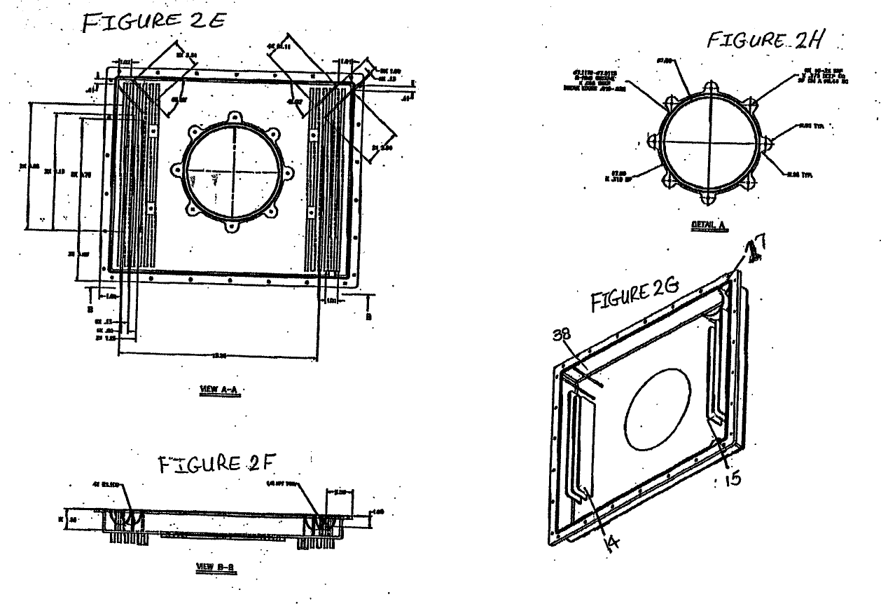

The interior of the color changer 1 houses a pair of heat exchangers 2 and 3. Referring to FIGS. 1, 1a, 1b, and 1d, heat exchanger 2 includes a pair of heat sinks 15 and 25 and a fan 40, and heat exchanger 3 includes a pair of heat sinks 14 and 24 and a fan 41. Referring to FIGS. 2a-d and 3a-d, the rear side of the front panel 10 is secured heat sinks 14 and 15, and on the rear side of the rear panel 20 is secured heat sinks 24 and 25. Fan 40 is secured within the housing via brackets 17 and 48, and fan 41 is secured within the housing via brackets 27 and 38. Preferably, the housing panels 10, with heat sink fins 14, 15, 18, 19 is manufactured as an single cast aluminum body, and the housing panel 20 with heat sink fins 24, 25, 28, 29 is similarly manufactured as a single case aluminum body. In addition, a transparent panel 50 made of a material that blocks or reflects ultra violet radiation is mounted on the interior of rear housing covering the cutout 21. The heat exchangers 2 and 3, heat sinks 18, 19, 28, 29, and panel 50 serve to dissipate heat generated by the beam of light “A” passing through the color changer 1 from light source 101.

In addition, as described above, a conventional color filter 54 such as the Color Fader™ color filter manufactured by Morpheus Technologies, LLC, and described generally in U.S. Pat. No. 5,126,886, is also mounted in the interior of the color changer 1. The filter 54 also includes a controller for controlling movement of the color filter, and conventional power distribution components for connecting the controller and fan to an external source of power. Preferably, the controller is a DMX 512 compatible controller.

What is claimed is:

1. An apparatus comprising:
a housing having a top side, a bottom side, a front side, a rear side, and a pair of lateral sides, the housing having a first window on the front side and a second window on the rear side;
a color filter disposed within the housing; and
at least one heat exchanger disposed within the housing, the housing being substantially impermeable to water.

2. The apparatus according to claim 1, wherein a pair of heat exchangers are disposed within the housing.

3. The apparatus according to claim 1, wherein the heat exchanger comprising a heat sink and a fan.

4. The apparatus according to claim 3, wherein the heat sink comprises a plurality of fins.

5. The apparatus according to claim 1, further comprising a transparent panel covering the second window, transparent panel being made of a material that blocks or reflects ultra violet radiation covering the second window.
